(19) United States
(12) Patent Application Publication
(10) Pub. No.: US 2009/0293226 A1
(43) Pub. Date: Dec. 3, 2009

(54) SPRING HOOK WEAR BUSHING AND LINKAGE ASSEMBLY INCLUDING THE SPRING HOOK WEAR BUSHING

(75) Inventors: Gerald A. Widemark, Phoenix, AZ (US); Gary W. Graham, Phoenix, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.,, Morristown, NJ (US)

(21) Appl. No.: 12/129,988

(22) Filed: May 30, 2008

(51) Int. Cl. H02G 3/22; F16H 25/18

(52) U.S. Cl. 16/2.1; 74/107

(57) ABSTRACT

A spring-hook wear bushing and actuator linkage assembly including the spring-hook wear bushing is provided. The wear bushing includes a cylindrical body having an annular external surface and including a first end and a second end. A bore is formed axially through the cylindrical body and extending from the first end to the second end. A channel is defined in the annular external surface of the cylindrical body and extending annular about the cylindrical body. The channel defines a running surface bounded by a plurality of annular retaining shoulders configured to retain therein a spring-hook of an actuator linkage assembly. The actuator linkage assembly is used for controlling a valve assembly.

### TECHNICAL FIELD

The present invention generally relates to a wear bushing, and more particularly relates to a composite spring-hook wear bushing for use in an actuator linkage assembly of a control valve.

### BACKGROUND

Fluid control valves and valve actuators are commonly utilized for controlling the flow of fluids in many engine systems, such as those commonly found in aircraft turbine engines. Many of these fluid flow control valves utilize sliding stem control valves or rotary action control valves that rely on a valve actuator to control the flow of fluid through the system. Valve actuators, including pneumatic piston or diaphragm actuators, respond to a valve controller for control of the associated valve. Valve actuators typically employ an actuator linkage assembly including a linearly movable member for control of the valve. In this type of actuator linkage assembly, linear movement of the linear moveable member is translated into rotational movement and actuation of the control valve.

Valve actuator linkage assemblies may employ a helical extension spring formed of a wire to link together rotational and articulating components. In many applications, the helical extension spring is formed having a hook configuration on at least one end. The hooked end provides for assembly about a mounting pin, thus providing the required linkage of the assembly components. Typically, there is provided a means on the mounting pin, such as a slide-off retaining component, or a similar part of the system to keep the spring-hook from sliding off the end of the mounting pin. Wear of the spring wire material is experienced on the hook end due to the spring wire contacting and wearing on interfacing components. More specifically, as the pin rotates during valve actuation, the spring wire wears at the inner diameter of the hook due to the contact with the mounting pin and/or wears on the sides of the hook from contact with the slide-off retaining feature, or from other components of the linkage mechanism.

Therefore, there is a need for a spring-hook wear bushing that provides for less wear on a hook end of the spring-hook. In addition, there is a need for a linkage assembly including the spring-hook wear bushing that provides for the rotating and articulating of linkage components without causing undue wear on the spring-hook. In addition, it is desirable for the spring-hook wear bushing to be relatively low cost and simple to install in the actuator linkage assembly. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

The present invention provides a spring-hook wear bushing and an actuator linkage assembly including the spring-hook wear bushing. In one embodiment, and by way of example only, the wear bushing comprises a cylindrical body having an annular external surface and including a first end and a second end. The wear bushing further comprises: a bore formed axially through the cylindrical body and extending from the first end to the second end; and a channel formed in the annular external surface of the cylindrical body and extending annular about the cylindrical body. The channel defines a running surface bounded by a plurality of annular retaining shoulders configured to retain therein a spring-hook.

In another particular embodiment, and by way of example only, there is provided a wear bushing comprising: a cylindrical body having an annular external surface and including a first end and a second end, the cylindrical body formed of a composite material; a bore formed axially through the cylindrical body and extending from the first end to the second end; and a channel formed in the annular external surface of the cylindrical body and extending annular about the cylindrical body. The channel defines a running surface bounded by a plurality of annular retaining shoulders configured to retain therein a spring-hook.

In yet another particular embodiment, and by way of example only, there is provided an actuator linkage assembly for use in controlling a valve. The actuator linkage assembly comprising: a linear moveable element configured to receive a linear movement; an actuator link including an arm actuating assembly coupled to the linear moveable element; and a feedback arm coupled to the actuator link via a helical extension spring including a spring-hook. The actuator link and the arm actuating assembly configured to transform the linear movement of the linear moveable element into a rotational movement via the feedback arm. The feedback arm including a mounting pin having a wear bushing disposed thereon, the wear bushing comprising: a cylindrical body having an annular external surface and including a first end and a second end; a bore formed axially through the cylindrical body and extending from the first end to the second end; a channel formed in the annular external surface of the cylindrical body and extending annular about the cylindrical body. The channel formed in the wear annular external surface defines a running surface bounded by a plurality of annular retaining shoulders configured to retain therein the spring-hook.

Other independent features and advantages of the preferred spring-hook wear bushing and linkage assembly including the spring-hook wear bushing will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and

FIG. 1 is an isometric view of a spring-hook wear bushing according to an embodiment;

FIG. 2 is a simplified sectional view of a spring-hook wear bushing according to an embodiment;

FIG. 3 is a side view of a linkage assembly including the spring-hook wear bushing of FIGS. 1 and 2; and

FIG. 4 is an end view of a linkage assembly including the spring-hook wear bushing of FIGS. 1 and 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. This invention addresses the wear problem for helical extension springs utilized in rotational and articulating component applications and more particularly the wear on the spring-hook. This invention provides a composite wear bushing that effectively uses a mounting pin onto which it is disposed as an axle, thereby transferring the rotational motion between the spring-hook and the mounting pin to the wear bushing and the mounting pin. This eliminates the wear point typically formed between the spring-hook and the mounting pin. In addition, the wear bushing is designed to include a slide-off retainer thereby eliminating the wear interface typically formed between the spring-hook and the retaining means.

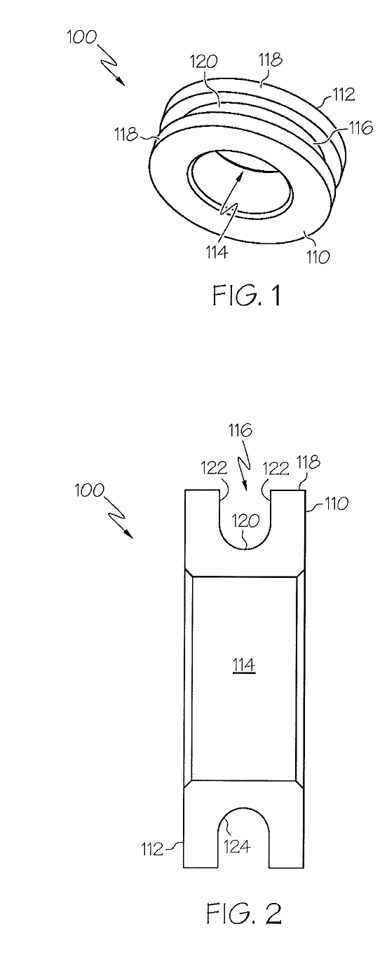

Referring now to FIGS. 1 and 2, illustrated is a spring-hook wear bushing, generally referred to herein as wear bushing 100. The wear bushing 100 is formed as a one piece component that is generally cylindrical in shape. More specifically, the wear bushing 100 includes a first end 110, a second end 112, and an inner bore 114 which defines an opening therethrough extending from the first end 110 to the second end 112. The wear bushing 100 also includes a channel 116 formed in an exterior annular surface 118. The channel 116 provides for a running surface 120 of a spring-hook (not shown) when the wear bushing 100 is incorporated into an actuator linkage assembly (discussed presently). In the illustrated embodiment, the running surface 120, and more particularly the channel 116, defines a first and second shoulder 122 and a generally curved lower aspect 124. The first and second shoulders 122 provide a retaining means for a spring-hook (not shown) when positioned within the channel 116. In this preferred embodiment, the wear bushing 100 is manufactured from composite material, such as polyimide. Other suitable materials capable of providing low friction and low wear may also be used to form the wear bushing 100. Dimensionally, the wear bushing 100 is either molded or machined from the composite material using normal molding or machining fabrication processes and equipment. The wear bushing 100 is fabricated to a specific size for incorporation into a specific actuator linkage assembly or for use with a specific gauge spring-hook wire. Accordingly, the wear bushing 100 could be made larger or smaller to address specific applications and proportionally differently-sized than that shown in the accompanying FIGs.

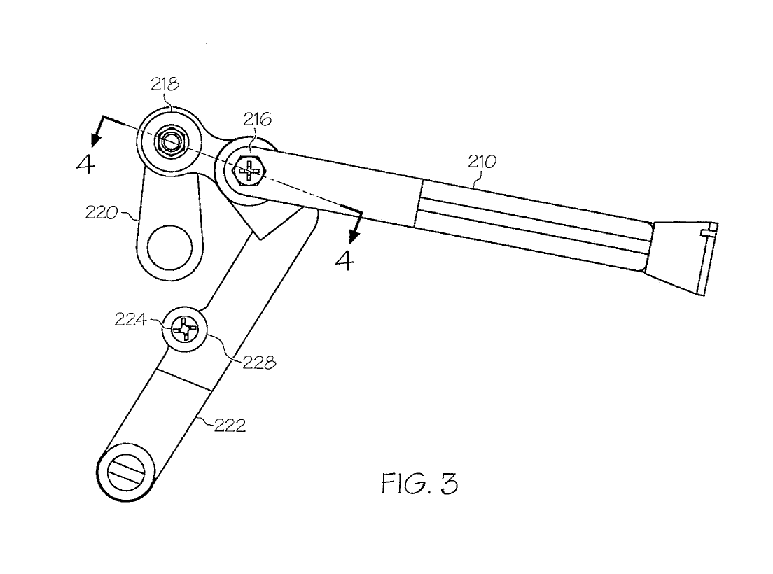

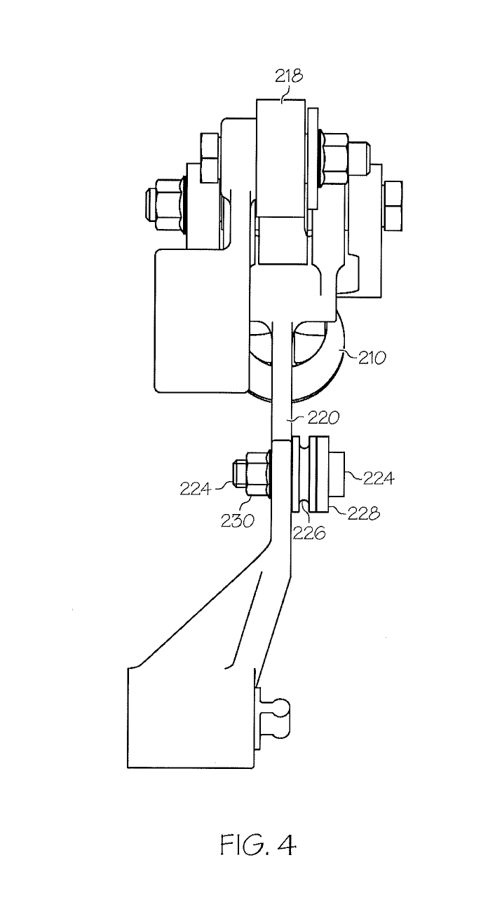

Referring now to FIGS. 3 and 4, illustrated is an actuator linkage assembly 200, typical of the type utilized in a valve system, such as a pre-cooler control valve found in aircraft. The actuator linkage assembly 200 includes a linear moveable member 210 configured to receive a linear movement. The linear moveable member 210 in this particular embodiment is a moving canister driven by a pressurized bladder. In an alternative embodiment, the linear force may be delivered via a moving diaphragm under a pressure difference. An end 216 of the linear moveable member 210 is coupled by an actuator link 218, including an arm actuating assembly 220, to a feedback arm 222. The actuator link 218 and arm actuating assembly 220 transform the actuating linear movement of the linear moveable member 210 to rotary movement of the rotatable feedback arm 222. The feedback arm 222 includes a mounting pin 224 (FIG. 4) for the coupling thereto of the arm actuating assembly 220. In the illustrated embodiment the mounting pin 224 is a machine screw that has disposed thereon a wear bushing 226, generally similar to the spring-hook wear bushing 100 of FIGS. 1 and 2. It should be understood that mounting pin 224 may alternatively be formed as a pin shaped component that is fixedly coupled to the feedback arm 222. The wear bushing 226 is retained on the mounting pin 224 by a stepped retaining sleeve 228. A locking means 230, such as a self-locking nut, is provided on an opposed end of the mounting pin 224 to retain the assembly in proper position.

As best illustrated in FIG. 4, during actuation of the actuator linkage assembly 200, the linear moveable member 210 receives a linear movement, which in turn transfers the linear movement into a rotational movement via the feedback arm 222. This transfer of motion causes the retaining sleeve 228 to become the axle by transferring the rotational motion that in the prior art exists between a spring-hook (not shown) disposed on a mounting pin, to the wear bushing 226 and the retaining sleeve 228. This transfer of rotational motion eliminates the wear point between the spring-hook and the mounting pin 224. In addition, the first and second shoulders 122 (FIG. 2) formed in the wear bushing 226 eliminate the wear interface between the spring-hook and the retaining sleeve 228.

While the prior art has reported using bushings, none have established a basis for a specific bushing design that is dedicated to the task of resolving the particular problem at hand. What is needed in this instance is a wear bushing that can be releasably secured to a mounting pin of a linkage assembly, whereby a spring-hook when attached to the wear bushing does not encounter frictional wear due to the rotating and articulating of the actuator linkage assembly components with the spring-hook. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A wear bushing comprising:
a cylindrical body having an annular external surface and including a first end and a second end;
a bore formed axially through the cylindrical body and extending from the first end to the second end; and
a channel formed in the annular external surface of the cylindrical body and extending annular about the cylindrical body,
wherein the channel defines a running surface bounded by a plurality of annular retaining shoulders configured to retain therein a spring-hook.

2. A wear bushing as claimed in claim 1, wherein the wear bushing is formed of a composite material.

3. A wear bushing as claimed in claim 2, wherein the wear bushing is formed of a polyimide.

4. A wear bushing as claimed in claim 3, wherein the wear bushing is formed of a molded polyimide.

5. A wear bushing as claimed in claim 3, wherein the wear bushing is formed of a machined polyimide.

6. A wear bushing comprising:
a cylindrical body having an annular external surface and including a first end and a second end, the cylindrical body formed of a composite material;
a bore formed axially through the cylindrical body and extending from the first end to the second end; and
a channel formed in the annular external surface of the cylindrical body and extending annular about the cylindrical body,
wherein the channel defines a running surface bounded by a plurality of annular retaining shoulders configured to retain therein a spring-hook.

7. A wear bushing as claimed in claim 6, wherein the wear bushing is formed of a polyimide.

8. A wear bushing as claimed in claim 7, wherein the wear bushing is formed of a molded polyimide.

9. A wear bushing as claimed in claim 7, wherein the wear bushing is formed of a machined polyimide.

10. An actuator linkage assembly for use in controlling a valve, the actuator linkage assembly comprising:
a linear moveable element configured to receive a linear movement;
an actuator link including an arm actuating assembly coupled to the linea moveable element;
a feedback arm coupled to the actuator link via a helical extension spring including a spring-hook, the actuator link and the arm actuating assembly configured to transform the linear movement of the linear moveable element into a rotational movement via the feedback arm, the feedback arm including a mounting pin having a wear bushing disposed thereon, the wear bushing comprising:
a cylindrical body having an annular external surface and including a first end and a second end;
a bore formed axially through the cylindrical body and extending from the first end to the second end;
a channel formed in the annular external surface of the cylindrical body and extending annular about the cylindrical body,
wherein the channel defines a running surface bounded by a plurality of annular retaining shoulders configured to retain therein the spring-hook.

11. The actuator linkage assembly of claim 10, wherein the linear moveable element is a moving canister driven by a pressurized bladder.

12. The actuator linkage assembly of claim 10, wherein the mounting pin is a machine screw positioned within a bore formed in the feedback arm.

13. The actuator linkage assembly of claim 10, wherein the mounting pin is a pin-shaped component fixedly mounted to the feedback arm.

14. The actuator linkage assembly of claim 10, further including a locking means disposed on an end of the mounting pin, thereby locking the mounting pin in position relative to the feedback arm.

15. The actuator linkage assembly of claim 14, wherein the locking means is a self-locking nut.

16. The actuator linkage assembly of claim 10, further including a retaining sleeve disposed on the mounting pin to retain position of the wear bushing relative to the mounting pin.

17. The actuator linkage assembly of claim 10, wherein the wear bushing is formed of a composite material.

18. The actuator linkage assembly of claim 17, wherein the wear bushing is formed of a polyimide material.

19. The actuator linkage assembly of claim 18, wherein the wear bushing is formed of a molded polyimide material.

20. The actuator linkage assembly of claim 18, wherein the wear bushing is formed of a machined polyimide material.
